(19) United States
(12) Patent Application Publication
(10) Pub. No.: US 2010/0255297 A1
(43) Pub. Date: Oct. 7, 2010

(54) PRESSURE-SENSITIVE ADHESIVE SHEET AND METHOD OF MANUFACTURE THEREOF

(75) Inventors: Shouhei WADA, Ibaraki-shi (JP); Mitsuyoshi SHIRAI, Ibaraki-shi (JP); Toshihide SUZUKI, Ibaraki-shi (JP); Kenichi YAMAMOTO, Ibaraki-shi (JP); Akiko TAKAHASHI, Ibaraki-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: NITTO DENKO CORPORATION, Ibaraki-shi (JP)

(21) Appl. No.: 12/754,292

(22) Filed: Apr. 5, 2010

(30) Foreign Application Priority Data
Apr. 7, 2009 (JP) 2009-093110

(51) Int. Cl. C09J 7/00; C09J 7/02; B05D 5/10

(52) U.S. Cl. 428/343; 427/208.4; 524/832

(57) ABSTRACT

The present invention provides a pressure-sensitive adhesive sheet minimizing the corrosion of metals not in contact with the PSA sheet. PSA sheet 54 has a pressure-sensitive adhesive layer formed from an aqueous pressure-sensitive adhesive composition comprising an adhesive ingredient and a preservative in an aqueous medium. In a metal corrosion test carried out by placing 1 g of the PSA sheet 54 and a silver plate 56 so as not to be in mutual contact in a 50 mL vessel 52 and then closing and holding the vessel 52 at 85° C. for one week, the PSA sheet 54 does not corrode the silver plate 56.

### BACKGROUND OF THE INVENTION

1. Field of the Invention

The present invention relates to a pressure-sensitive adhesive (PSA) sheet adapted for use inside electronic equipment, and a method of manufacturing such a sheet.

This application claims priority from Japanese Patent Application No. 2009-93110, filed on Apr. 7, 2009, the entire contents of which are incorporated herein by reference.

2. Description of the Related Art

From the standpoint of environmental health, aqueous PSA compositions of an adhesive ingredient contained within an aqueous medium (e.g., emulsion-type PSA compositions composed of an adhesive ingredient dispersed in an aqueous medium) are preferable to PSA compositions of an adhesive ingredient dissolved in an organic solvent (solvent-based PSA compositions). Accordingly, PSA sheets produced using aqueous PSA compositions, whether as double-sided tape or in some other form, have come to be used in a variety of fields. Examples of such fields of use include various types of electronic equipment, such as home appliances and office automatic equipment. Technical literature relating to such art includes Japanese Patent Application Publication No. S61-12775.

### SUMMARY OF THE INVENTION

However, depending on the manner of use, PSA sheets formed from aqueous PSA compositions sometimes cause metals (e.g., silver) which are not in direct contact with the PSA sheet to corrode. For example, under circumstances where a PSA sheet and a metallic material are both present within a confined space, such as at the interior of the housing for an electronic device, corrosion sometimes arises in the metallic material which is not in contact with the PSA sheet. Such a situation may become a cause that gives rise to poor electrical contact due to corrosion of the metal making up, for example, the substrate or wiring of the electronic device. Therefore, the quality of not causing metal to corrode is especially desired in PSA sheets for use inside electronic devices.

It is therefore an object of the present invention to provide a PSA sheet having a PSA layer made from an aqueous PSA composition, which PSA sheet is adapted for use inside electronic devices and minimizes the corrosion of metals not in contact with the PSA sheet. Another object of the invention is to provide a method of manufacturing such a PSA sheet.

The inventors, thinking that the corrosion of non-contact metals caused by a PSA sheet may arise due to the release of metal-corroding substances from the PSA sheet, have conducted various investigations on the origin of such metal-corroding substances. As a result, it was found that, although preservatives included as needed to prevent the spoilage of aqueous PSA compositions are generally added in very small amounts, surprising as it may seem, they can become a major cause of such metal corrosion. The inventors ultimately discovered that this problem can be resolved by using a preservative which has very little or no tendency to corrode metals.

Accordingly, this invention provides a method of manufacturing a PSA sheet which is adapted for use inside electronic devices and comprises a PSA layer formed from an aqueous PSA composition. This method includes the steps of preparing an aqueous PSA composition containing an adhesive ingredient and a preservative in an aqueous medium, and forming the PSA layer by drying the PSA composition. The preservative used here is one which, in a metal corrosion test carried out by placing 1.7×10⁻⁵ g of the preservative and a silver plate so as not to be in mutual contact within a 50 mL vessel and then closing and holding the vessel at 85° C. for one week, does not corrode the silver plate.

In this method, a preservative which passes the metal corrosion test (i.e., which does not corrode the silver plate) is used as the preservative included in the aqueous PSA composition for forming the PSA layer. By using this aqueous PSA composition, a PSA sheet which has little or no tendency to corrode metals (particularly silver) and is thus suitable for use inside electronic devices can be manufactured. Moreover, because the PSA composition contains a preservative, spoilage does not readily occur during, for example, production, transportation and storage of the composition. A PSA composition having such a good shelf stability is desirable because, owing to easy production control and the like, it can help to reduce production costs.

The inventors have discovered that compounds having a thiocyanate group and compounds having a thioacetal group readily corrode the silver plate in the metal corrosion test. Therefore, it is preferable to use as the preservative one or more compound selected from among compounds without either a thiocyanate group or a thioacetal group. In this way, PSA sheets having little tendency to corrode metal can be efficiently designed and manufactured.

It is preferable for the PSA composition to contain the preservative in a concentration of at least 1 ppm. Such a PSA composition is better able to prevent spoilage in production, transportation and storage of the composition. A PSA composition having such good shelf stability is desirable because, owing to the ease of production control and the like, it can help to reduce production costs.

In a preferred embodiment of the art disclosed herein, the PSA composition does not exhibit spoilage in an anti-spoilage test carried out by placing 20 g of the composition in a 50 mL vessel in open air and then closing and holding the vessel at 30° C. for one week. A PSA composition having such excellent anti-spoilage properties (that is, good shelf stability) is desirable because, owing to the ease of production control and the like, it can help to reduce production costs.

In another preferred embodiment, the PSA composition comprises an acrylic polymer as a base polymer (typically a main component of polymer components) of the adhesive ingredient and is an emulsion of the acrylic polymer dispersed in water (acrylic emulsion-type PSA composition).

The present invention also provides a PSA sheet adapted for use inside an electronic device. This sheet has a PSA layer made from an aqueous PSA composition comprising an adhesive ingredient and a preservative in an aqueous medium. The PSA sheet is characterized in that, in a metal corrosion test carried out by placing 1 g of the PSA sheet and a silver plate so as not to be in mutual contact within a 50 mL vessel and then closing and holding the vessel at 85° C. for one week, the PSA sheet does not corrode the silver plate. Because this PSA sheet has very little or no tendency to corrode metal (particularly silver), it is highly suitable as a PSA sheet for use inside electronic devices. The preservative is a compound without either a thiocyanate group or a thioacetal group.

An example of a preferred target application for the art disclosed herein is a double-sided PSA sheet (a PSA sheet adhesive on both sides) composed of a substrate having on each side thereof the PSA layer. In a PSA sheet having such a construction, the amount of PSA included in a unit weight of the PSA sheet is large, as a result of which the amount of preservative also tends to become large. In a PSA sheet containing much PSA per unit weight such as this, employing the invention disclosed herein is especially meaningful.

Because the PSA sheet provided by the art disclosed herein (which may be a PSA sheet manufactured by any method disclosed herein) has very little or no tendency to corrode metal, it is highly suitable as a PSA sheet for use inside an electronic device. For example, it can be advantageously employed as a PSA sheet (typically a double-sided PSA sheet such as mounting sheet) used for bonding (mounting) within an internal space where it is present together with metal materials such as a circuit board or wiring. This invention thus provides, according to another aspect, an electronic device which has at the interior thereof places that are bonded by means of the PSA sheet.

The subject matter disclosed in the present specification includes the following:

(1) A PSA sheet manufactured by any of the methods disclosed herein, which sheet, in a metal corrosion test carried out by placing 1 g of the PSA sheet and a silver plate so as not to be in mutual contact with each other within a 50 mL vessel and then closing and holding the vessel at 85° C. for one week, does not corrode the silver plate;
(2) An aqueous PSA composition for manufacturing a PSA sheet adapted for use in bonding at the interior of an electronic device, the composition comprising an aqueous medium, an adhesive ingredient dissolved or dispersed in the aqueous medium, and a preservative. The preservative, in a metal corrosion test carried out by placing 1.7×10⁻⁵ g of the preservative and a silver plate so as not to be in mutual contact with each other within a 50 mL vessel and then closing and holding the vessel at 85° C. for one week, does not corrode the silver plate;
(3) A method of producing an aqueous PSA composition for manufacturing a PSA sheet adapted for use in bonding at the interior of an electronic device, the method comprising the steps of: selecting a preservative which, in a metal corrosion test carried out by placing 1.7×10⁻⁵ g of the preservative and a silver plate so as not to be in mutual contact within a 50 mL vessel and then closing and holding the vessel at 85° C. for one week, does not corrode the silver plate; and preparing an aqueous PSA composition containing an adhesive ingredient and the preservative in an aqueous medium; and
(4) A method of manufacturing a PSA sheet which is adapted for use inside an electronic device and has a PSA layer made from an aqueous PSA composition, the method comprising the steps of: selecting a preservative which, in a metal corrosion test carried out by placing 1.7×10⁻⁵ g of the preservative and a silver plate so as not to be in mutual contact within a 50 mL vessel and then closing and holding the vessel at 85° C. for one week, does not corrode the silver plate; preparing an aqueous PSA composition containing an adhesive ingredient and the preservative within an aqueous medium; and forming the PSA layer by drying the PSA composition.

### BRIEF DESCRIPTION OF THE DRAWINGS

FIG. 1 is a schematic cross-sectional view of an embodiment of the PSA sheet according to the present invention.

FIG. 2 is a schematic cross-sectional diagram of another embodiment of the PSA sheet according to the invention.

FIG. 3 is a schematic cross-sectional diagram of yet another embodiment of the PSA sheet according to the invention.

FIG. 4 is a schematic cross-sectional diagram of a further embodiment of the PSA sheet according to the invention.

FIG. 5 is a schematic cross-sectional diagram of a still further embodiment of the PSA sheet according to the invention.

FIG. 6 is a schematic cross-sectional diagram of an additional embodiment of the PSA sheet according to the invention.

FIG. 7 is a diagram which schematically illustrates a method of carrying out a metal corrosion test.

### DETAILED DESCRIPTION OF THE INVENTION

Following is a detailed description of preferred embodiments of the present invention. Note that technical matters that are required for carrying out the present invention but are not particularly mentioned in the present specification are matters of design variation that could be apprehended by a person skilled in the art based on prior art. The present invention can be carried out based on the technical details disclosed in the present specification and on common general technical knowledge in the field in question. In the following description, members or features having like functions are designated by like symbols, and repeated explanations may be omitted or simplified.

The PSA sheet provided by this invention has a PSA layer formed by using one of the PSA compositions disclosed herein. It may be a PSA sheet with substrate in a form having the PSA layer on one side or both sides of a substrate (base material), or a substrate-less PSA sheet in which the PSA layer is held on a release liner (which may also be understood to be a substrate having a release face). The notion of a PSA sheet as used herein may encompass, for example, what are commonly referred to as PSA tape, PSA labels and PSA film. The PSA layer, although typically formed continuously, is not limited to such a configuration and may instead be a PSA layer formed in a regular (e.g., dotted or striped) pattern or in a random pattern. The PSA sheet provided by the present invention may be shaped as a roll or as single sheets. Alternatively, the PSA sheet may be in a form that has been fashioned into any of various other shapes.

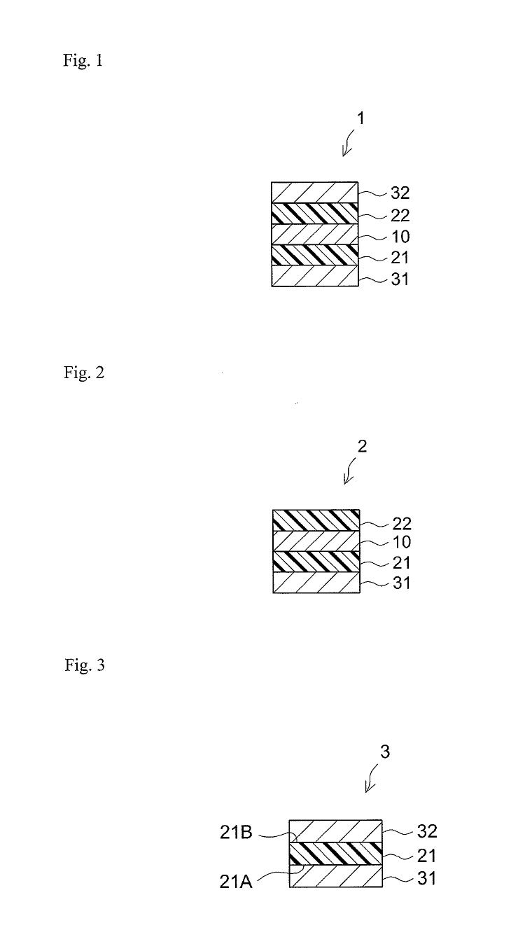

The PSA sheet disclosed herein may have, for example, the cross-sectional structures shown schematically in FIGS. 1 to 6. Of these diagrams, FIGS. 1 and 2 show examples of double-sided PSA sheet-with-substrate constructions. The PSA sheet 1 shown in FIG. 1 has a construction wherein PSA layers 21 and 22 are provided on either side (both of which are non-releasable) of a substrate 10, and these PSA layers are respectively protected by release liners 31 and 32, each of which has a release face on at least the PSA layer side thereof. The PSA sheet 2 shown in FIG. 2 has a construction wherein PSA layers 21 and 22 are provided on either side (both of which are non-releasable) of a substrate 10, and one of these—PSA layer 21—is protected by a release liner 31 having a release face on each side thereof. By rolling up this PSA sheet 2 and placing the other PSA layer 22 directly against the back face of the release liner 31, the PSA sheet 2 can be given a configuration in which the PSA layer 22 also is protected by the release liner 31.

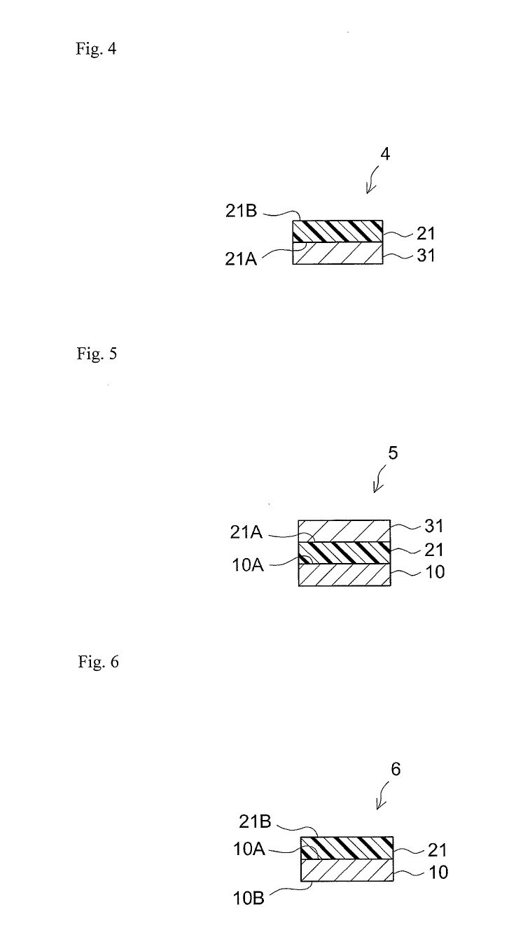

FIGS. 3 and 4 show examples of substrate-less double-sided PSA sheet constructions. The PSA sheet 3 shown in FIG. 3 has a construction wherein the two faces 21A and 21B of a substrate-less PSA layer 21 are protected by, respectively, release liners 31 and 32, each of which has a release face on at least the PSA layer side thereof. The PSA sheet 4 shown in FIG. 4 has a construction wherein a first face 21A of a substrate-less PSA layer 21 is protected by a release liner 31 having a release face on each side thereof. By rolling up this PSA sheet 4 and placing the second face 21B of the PSA layer 21 directly against the back face of the release liner 31, the PSA sheet 4 can be given a configuration in which the second face 21B also is protected by the release liner 31.

FIGS. 5 and 6 show examples of single-sided (adhesive on one side) PSA sheet-with-substrate constructions. The PSA sheet 5 shown in FIG. 5 has a construction wherein a PSA layer 21 is provided on a first face 10A (non-releasable face) of a substrate 10, and a first surface (bonding face) 21A of the PSA layer 21 is protected by a release liner 31 having a release face on at least the PSA layer side thereof. The PSA sheet 6 shown in FIG. 6 has a construction wherein a PSA layer 21 is provided on a first face 10A (non-releasable face) of a substrate 10. A second face 10B of the substrate 10 is a release face. When this PSA sheet 6 is rolled up, the second face 10B is brought directly against the PSA layer 21, and a second face (bonding face) 21B of the PSA layer 21 is protected by the second face 10B of the substrate 10.

The PSA composition used to create this PSA layer is an aqueous PSA composition in the form of an adhesive ingredient dissolved or dispersed in an aqueous medium. As used herein, “aqueous medium” refers to a medium wherein the solvent making up the medium is water or a mixed solvent composed primarily of water (aqueous solvent). The concept of an aqueous PSA composition encompasses what are generally called aqueous dispersion-type (typically, emulsion-type) PSA compositions and water-soluble PSA compositions. Typical examples of the aqueous PSA compositions in the art disclosed herein are aqueous emulsion-type PSA compositions.

Although such aqueous PSA compositions have an advantage over solvent-based PSA compositions in terms of environmental health, unlike in solvent-based PSA compositions, microorganisms are able to grow within aqueous PSA compositions. As a result, such compositions tend to spoil under ordinary storage conditions. In the aqueous PSA composition disclosed herein, a preservative is added to prevent such a situation from arising and thereby increase the shelf stability of the PSA composition. Accordingly, this is an aqueous PSA composition which comprises an adhesive ingredient and a preservative in an aqueous medium.

The PSA sheet provided by the art disclosed herein is characterized in that, in a metal corrosion test carried out by placing 1 g of the PSA sheet and a silver plate (using, for example, a plate made of silver having a purity in excess of 99.95% and having a size of 1 mm×10 mm×10 mm) so as not to be in mutual contact with each other within a 50 mL vessel and then closing and holding the vessel at 85° C. for one week, the PSA sheet does not corrode the silver plate. Hence, this sheet is advantageous as a PSA sheet for use inside an electronic device. In the case of PSA sheets with a substrate like those shown in FIGS. 1, 2, 5 and 6, the one-gram weight of the PSA sheet used in this test is the overall weight that includes the PSA layer(s) and the substrate (but does not include any release liners). In the case of substrate-less PSA sheets like those shown in FIGS. 3 and 4, the one-gram weight of the PSA sheet used in this test represents the weight of the PSA layer proper.

This PSA sheet has a PSA layer formed using an aqueous PSA composition which includes a preservative. The PSA sheet thus contains the preservative from the PSA composition that is used. This preservative is preferably one which, in a metal corrosion test carried out by placing 1.7×10⁻⁵ g of the preservative and a silver plate (using, for example, a plate made of silver having a purity in excess of 99.95% and having a size of 1 mm×10 mm×10 mm) so as not to be in mutual contact with each other within a 50 mL vessel and then closing and holding the vessel at 85° C. for one week, does not corrode the silver plate. The preservative used in the art disclosed herein may be a single preservative, or a suitable combination of preservatives, selected from among various known materials which pass this metal corrosion test (i.e., which do not corrode the silver plate in this test). In the present invention, the phrase “do not corrode the silver plate” means that the silver plate following the metal corrosion test (after one week has elapsed) and the silver plate prior to use (before the test), when compared by visual examination, show no change in appearance (e.g., loss of metallic luster, discoloration).

The inventor has discovered that compounds having a thiocyanate group and compounds having a thioacetal group tend to corrode the silver plate in this metal corrosion test. This is presumably because compounds having a thioacetal group, due to the thermal history incurred when the PSA layer is formed by drying the PSA composition or during storage or use of the PSA sheet, readily form volatile compounds containing sulfur as a constituent element (e.g., gases containing sulfur as a constituent element), such as mercaptan and disulfide, as thermal decomposition products. When such sulfur-containing gases are released from the PSA sheet, this may cause the corrosion of metals (e.g., silver) which are not in contact with the PSA sheet. The preservative used in the art disclosed herein is preferably selected from among materials having very low emissions of such volatile, metal-corroding substances. Therefore, in selecting this preservative, it is preferable to avoid compounds having a thiocyanate group and compounds having a thioacetal group (e.g., methylene dithioisocyanate and 2-(thiocyanomethylthio)benzothiazole).

Illustrative examples of preservatives that may be preferably used in the art disclosed herein include thiazoline preservatives (e.g., 2-methyl-4-isothiazolin-3-one, 5-chloro-2-methyl-4-isothiazolin-3-one), cyanoacetamide preservatives (e.g., halocyanoacetamides such as 2,2-dibromo-2-cyanoacetamide), and phenol and phenyl ester preservatives (e.g., pentachlorophenyl laurate, 2,4,6-tribromophenol).

The amount of the preservative used is not subject to any particular limitation, provided it is an amount which confers the anti-spoilage performance desired for the intended application or mode of use of the PSA composition. For example, the amount of the preservative per part by weight of the aqueous PSA composition may be set to at least about 1×10⁻⁷ part by weight (i.e., 0.1 ppm, weight basis), and typically from about 0.1 ppm to about 1,000 ppm. It is generally suitable to set the amount of preservative per part by weight of the aqueous PSA composition to at least about 1×10⁻⁶ part by weight (i.e., 1 ppm, weight basis), and typically from about 1 ppm to about 500 ppm. If the amount of preservative is too low, the anti-spoilage properties of the PSA composition tend to be inadequate. On the other hand, if the content of preservative is too high, the adhesiveness tends to decrease.

The PSA composition in the art disclosed herein is preferably a composition having a degree of anti-spoilage properties such that spoilage is not observable in an anti-spoilage test carried out by placing 20 g of the composition in a 50 mL vessel in the open air and then closing and holding the vessel at 30° C. for one week. A PSA composition having such excellent anti-spoilage properties (in other words, good shelf stability) can help lower production costs because, for example, production control is easy. Hence, with such a PSA composition, a PSA sheet in which the metal-corroding tendency has been minimized can be provided at a low cost. In the present invention, the phrase “spoilage is not observable” means that when the cap on the bottle is opened following this anti-spoilage test (after one week has elapsed) and the presence or absence of a putrid smell is sensory tested (by sniffing), a putrid smell cannot be detected.

The adhesive ingredient may be a substance containing as the base polymer any of various known polymers capable of forming a PSA, such as acrylic, rubber, polyester, urethane, polyether, silicone, polyimide and fluorinated polymers. As used herein, “base polymer” refers to a polymer serving as the basic ingredient of the PSA, and is typically the chief component of the polymer components included in the PSA. Preferred examples of the PSA composition in the art disclosed herein include aqueous PSA compositions wherein the chief component of the polymer components included in the PSA is an acrylic polymer. Of these, an emulsion-type composition of the above acrylic polymer dispersed in water (acrylic emulsion-type PSA composition) is preferred.

The invention is described more fully below primarily for, by way of illustration, cases in which the aqueous PSA composition is an acrylic emulsion-type PSA composition.

The acrylic emulsion-type PSA composition includes an aqueous dispersion of an acrylic polymer. This aqueous acrylic polymer dispersion is a composition in the form of an emulsion of an acrylic polymer dispersed in water. In the art disclosed herein, this acrylic polymer may be used as the base polymer of the PSA (the base ingredient of the PSA) in the PSA layer. For example, it is preferable for the acrylic polymer to account for at least 50 wt % of the PSA. This acrylic polymer is preferably one in which an alkyl (meth)acrylate serves as the chief monomeric ingredient (i.e., an ingredient which accounts for at least 50 wt % of the total amount of monomers making up the acrylic polymer).

In this specification, “(meth)acrylate” refers collectively to acrylate and methacrylate. Similarly, “(meth)acryloyl” refers collectively to acryloyl and methacryloyl, and “(meth)acryl” refers collectively to acryl and methacryl.

Preferred use may be made of a compound of Formula (1) below as the alkyl (meth)acrylate.

CH₂═C(R¹)COOR² (1)

In Formula (1), R¹ is a hydrogen or a methyl group, and R² is an alkyl group having from 1 to 20 carbon atoms. Illustrative examples of R² include alkyl groups such as methyl, ethyl, propyl, isopropyl, butyl, isobutyl, s-butyl, t-butyl, pentyl, isoamyl, neopentyl, hexyl, heptyl, octyl, isooctyl, 2-ethylhexyl, nonyl, isononyl, decyl, isodecyl, undecyl, dodecyl, tridecyl, tetradecyl, pentadecyl, hexadecyl, heptadecyl, octadecyl, nonadecyl and eicosyl. From the standpoint of such considerations as the storage elastic modulus, an alkyl (meth)acrylate in which R² is an alkyl group having from 2 to 14 carbon atoms (such a range in the number of carbon atoms is sometimes indicated below as “C₂₋₁₄”) is preferred, and an alkyl (meth)acrylate in which R² is a C₂₋₁₀ alkyl group is more preferred. Especially preferred examples of R² are butyl and 2-ethylhexyl.

In one preferred embodiment, at least about 50 wt % (more preferably at least 70 wt %, such as about 90 wt % or more) of the total amount of alkyl (meth)acrylate used to synthesize the acrylic polymer is an alkyl (meth)acrylate in which R² in Formula (1) is C₂₋₁₄ (preferably C₂₋₁₀, and more preferably C₄₋₈). With such a monomer makeup, an acrylic polymer having a storage elastic modulus near standard temperature that falls within a preferable range can readily be obtained. Essentially all of the alkyl (meth)acrylate used may be C₂₋₁₄ alkyl (meth)acrylate.

The alkyl (meth)acrylate making up the acrylic polymer in the art disclosed herein may be butyl acrylate (BA) alone, 2-ethylhexyl acrylate (2EHA) alone, or a combination of BA and 2EHA. When a combination of BA and 2EHA is used as the alkyl (meth)acrylate, the relative proportions thereof are not subject to any particular limitation.

Monomer components in the acrylic polymer may also include, within a range such that an alkyl (meth)acrylate is the chief ingredient, other monomers that are copolymerizable with the alkyl (meth)acrylate (also referred to below as “copolymerizable monomers”). The amount of alkyl (meth)acrylate relative to the overall amount of monomer components making up the acrylic polymer may be set to at least about 80 wt % (typically, from 80 to 99.8 wt %), and preferably at least 85 wt % (e.g., from 85 to 99.5 wt %). The amount of the alkyl (meth)acrylate may be at least 90 wt % (e.g., from 90 to 99 wt %).

The copolymerizable monomers may be useful for introducing crosslink points into the acrylic polymer or for increasing the cohesive strength of the acrylic polymer. These copolymerizable monomers may be used singly or as combinations of two or more thereof.

More specifically, various functional group-bearing monomers may be used as copolymerizable monomers for introducing crosslink points into the acrylic polymer (these are typically thermally crosslinkable functional group-bearing monomers for introducing into the acrylic polymer crosslink points that crosslink under the effect of heat). By using such functional group-bearing monomers, the adhesive strength with respect to the adherend can be enhanced. Such functional group-bearing monomers are not subject to any particular limitation, provided they are monomers which are copolymerizable with alkyl (meth)acrylate and are capable of providing functional groups that will serve as crosslink points. For example, functional group-bearing monomers such as those mentioned below may be used singly or as combinations of two or more thereof
Carboxyl group-bearing monomers: e.g., ethylenically unsaturated monocarboxylic acids such as acrylic acid, methacrylic acid and crotonic acid; ethylenically unsaturated dicarboxylic acid such as maleic acid, itaconic acid and citraconic acid, as well as anhydrides thereof (e.g., maleic anhydride, itaconic anhydride).
Hydroxyl group-bearing monomers: e.g., hydroxyalkyl (meth)acrylates such as 2-hydroxyethyl (meth)acrylate, 2-hydroxypropyl (meth)acrylate, 3-hydroxypropyl (meth)acrylate and 2-hydroxybutyl (meth)acrylate; and unsaturated alcohols such as vinyl alcohol and allyl alcohol.
Amide group-bearing monomers: e.g., (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide and N-butoxymethyl (meth)acrylamide.
Amino group-bearing monomers: e.g., aminoethyl (meth)acrylate, N,N-dimethylaminoethyl (meth)acrylate and t-butylaminoethyl (meth)acrylate.
Epoxy group-bearing monomers: e.g., glycidyl (meth)acrylate, methylglycidyl (meth)acrylate and allyl glycidyl ether.
Cyano group-bearing monomers: e.g., acrylonitrile, methacrylonitrile.
Keto group-bearing monomers: e.g., diacetone (meth)acrylamide, diacetone (meth)acrylate, vinyl methyl ketone, vinyl ethyl ketone, allyl acetoacetate and vinyl acetoacetate.
Monomers with a N-containing heterocyclic group: e.g., N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam and N-(meth)acryloylmorpholine.
Alkoxysilyl group-bearing monomers: e.g., 3-(meth)acryloxypropyltrimethoxysilane, 3-(meth)acryloxypropyltriethoxysilane, 3-acryloxypropyltriethoxysilane, 3-(meth)acryloxypropylmethyldimethoxysilane and 3-(meth)acryloxypropylmethyldiethoxysilane.

Of such functional group-bearing monomers, preferred use may be made of one or more selected from among carboxyl group-bearing monomers and acid anhydrides thereof. Substantially all of the functional group-bearing monomer ingredients may be carboxyl group-bearing monomers. Of these, examples of preferred carboxyl group-bearing monomers include acrylic acid and methacrylic acid. One of these may be used alone, or acrylic acid and methacrylic acid may be used together in any ratio.

It is advantageous to use the above functional group-bearing monomers in a range of up to about 12 parts by weight (e.g., from about 0.5 to about 12 parts by weight, and preferably from about 1 to about 8 parts by weight) in total per 100 parts by weight of the alkyl (meth)acrylate. If the amount of functional group-bearing monomers used is too high, the cohesive strength may become excessive, as a result of which the adhesive properties (e.g., bonding strength) may tend to decline.

To increase the cohesive strength of the acrylic polymer, additional use may be made of copolymerizable components other than the above functional group-bearing monomers. Illustrative examples of such copolymerizable components include vinyl ester monomers such as vinyl acetate and vinyl propionate; aromatic vinyl compounds such as styrene, substituted styrenes (e.g., α-methylstyrene) and vinyltoluene; nonaromatic ring-bearing (meth)acrylates such as cycloalkyl (meth)acrylates (e.g., cyclohexyl (meth)acrylate, cyclopentyl di(meth)acrylate) and isobornyl (meth)acrylate); aromatic ring-bearing (meth)acrylates such as aryl (meth)acrylates (e.g., phenyl (meth)acrylate), aryloxyalkyl (meth)acrylates (e.g., phenoxyethyl (meth)acrylate) and arylalkyl (meth)acrylates (e.g., benzyl (meth)acrylate); olefinic monomers such as ethylene, propylene, isoprene, butadiene and isobutylene; chlorinated monomers such as vinyl chloride and vinylidene chloride; isocyanate group-bearing monomers such as 2-(meth)acryloyloxyethyl isocyanate; alkoxy group-bearing monomers such as methoxyethyl (meth)acrylate and ethoxyethyl (meth)acrylate; and vinyl ether monomers such as methyl vinyl ether and ethyl vinyl ether.

Other examples of copolymerizable monomer ingredients include monomers having a plurality of functional groups in a molecule. Illustrative examples of such polyfunctional monomers include 1,6-hexanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly)propylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, glycerol di(meth)acrylate, epoxy acrylate, polyester acrylate, urethane acrylate, divinylbenzene, butyl di(meth)acrylate and hexyl di(meth)acrylate.

A known or conventional polymerization method may be employed as the method of polymerizing such monomers to obtain an aqueous dispersion-type acrylic polymer. Preferred use may be made of an emulsion polymerization process. When carrying out emulsion polymerization, suitable use may be made of monomer feed methods such as a batch charging method in which all the monomer starting material is fed at one time, a continuous feed (dropwise addition) method, or a divided feed (dropwise addition) method. Alternatively, part or all (typically all) of the monomer may be mixed beforehand with water (typically, a suitable amount of the subsequently described emulsifying agent is used together with water) and emulsified, and the resulting emulsified liquid (monomer emulsion) then fed batchwise, continuously, or in divided portions to the interior of the reaction vessel. The polymerization temperature may be selected as appropriate for the types of monomers used, the type of polymerization initiator, etc. For example, the polymerization temperature may be set to from about 20 to about 100° C. (typically from about 40 to about 80° C.).

The polymerization initiator used at the time of polymerization may be suitably selected, according to the type of polymerization method, from among known or conventional polymerization initiators. For example, in the emulsion polymerization method, preferred use may be made of an azo-type polymerization initiator. Illustrative examples of azo-type polymerization initiators include 2,2′-azobisisobutyronitrile, 2,2′-azobis(2-methylpropionamidine) disulfate, 2,2′-azobis(2-amidinopropane) dihydrochloride, 2,2′-azobis[2-(5-methyl-2-imidazolin-2-yl)propane]dihydrochloride, 2,2′-azobis(N,N′-dimethyleneisobutylamidine), 2,2′-azobis[N-(2-carboxyethyl)-2-methylpropionamidine]hydrate, 2,2′-azobis(4-methoxy-2,4-dimethylvaleronitrile), 2,2′-azobis(2,4-dimethylvaleronitrile), 2,2′-azobis(2-methylbutylonitrile), 1,1′-azobis(cyclohexane-1-carbonitrile), 2,2′-azobis(2,4,4-trimethylpentane) and dimethyl-2,2′-azobis(2-methylpropionate).

Further examples of polymerization initiators includes persulfates such as potassium persulfate and ammonium persulfate; peroxide initiators such as benzoyl peroxide, t-butyl hydroperoxide, di-t-butyl peroxide, t-butyl peroxy benzoate, dicumyl peroxide, 1,1-bis(t-butylperoxy)-3,3,5-trimethylcyclohexane, 1,1-bis(t-butylperoxy)cyclododecane and hydrogen peroxide; substituted ethane initiators such as phenyl-substituted ethane; aromatic carbonyl compounds; and the like. Still further examples of polymerization initiators include redox initiators such as a combination of a peroxide and reducing agent. Examples of such redox initiators include combinations of peroxides with ascorbic acid (e.g., the combination of an aqueous hydrogen peroxide solution with ascorbic acid), combinations of peroxides with ferric salts (e.g., combination of an aqueous hydrogen peroxide solution with a ferric salt), and combinations of persulfates with sodium bisulfite.

Such polymerization initiators may be used singly or as a combination of two or more types. The amount in which the initiator is used may be selected from a range of, for example, from about 0.005 to about 1 part by weight (typically from 0.01 to 1 part by weight) per 100 parts by weight of all the monomer components, provided it is an ordinary amount for this purpose. If the amount of the polymerization initiator is too large or too small, the desired adhesive performance may be difficult to achieve.

A chain transfer agent (which may also be thought of as a molecular weight modifier or a degree of polymerization regulator) may be optionally used in polymerization. Known or conventional chain transfer agents may be used with examples including mercaptans such as dodecyl mercaptan (dodecanethiol), lauryl mercaptan, glycidyl mercaptan, 2-mercaptoethanol, mercaptoacetic acid, 2-ethylhexyl thioglycolate and 2,3-dimethylcapto-1-propanol; α-methyl styrene dimer; and the like. Such chain transfer agents may be used singly or as a combination of two or more thereof. The amount of the chain transfer agent may be selected from a range of, for example, from about 0.001 to about 5 parts by weight (typically from about 0.005 to about 2 parts by weight, such as from about 0.001 to about 1 part by weight) per 100 parts by weight of the total monomers. For example, in the synthesis of an aqueous dispersion-type acrylic polymer for a double-sided PSA sheet, a chain transfer agent may be preferably used in an amount selected from the above range. A chain transfer agent content that is too high may tend to lower the degree of polymerization.

The chain transfer agent may, depending on the type thereof and manner of use (content, etc.), become a factor in the generation of metal-corroding gases which contain sulfur as a constituent element (e.g., H₂S, SO₂). The art disclosed herein may be advantageously carried out in a manner that does not involve the use of a chain transfer agent in the polymerization. In this way, metal corrosion caused by a chain transfer agent can be prevented beforehand.

In another preferred embodiment of the art disclosed herein, a chain transfer agent composed of a compound which does not contain sulfur as a constituent element is used. Typically, only a compound which does not contain sulfur as a constituent element is used as the chain transfer agent (that is, compounds containing sulfur as a constituent element are essentially not used). In this embodiment, because the above-mentioned sulfur-containing metal-corroding gases from chain transfer agents are not generated, metal corrosion caused by the chain transfer agent can be prevented beforehand. Illustrative examples of chain transfer agents composed of compounds which do not contain sulfur as a constituent element include anilines such as N,N-dimethylaniline and N,N-diethylaniline; terpenoids such as α-pinene and terpinolene; styrenes such as α-methylstyrene and α-methylstyrene dimer; benzylidenyl group-bearing compounds such as dibenzylidene acetone, cinnamyl alcohol and cinnamyl aldehyde; hydroquinones such as hydroquinone and naphthohydroquinone; quinones such as benzoquinone and naphthoquinone; olefins such as 2,3-dimethyl-2-butene, 1,5-cyclooctadiene and sorbic acid; alcohols such as phenol, benzyl alcohol and allyl alcohol; and benzenes such as diphenylbenzene and triphenylbenzene.

In yet another preferred embodiment of the art disclosed herein, a chain transfer agent which includes sulfur as a constituent element but does not readily generate a sulfur-containing metal-corroding gas is used during polymerization. Examples of such chain transfer agents include mercaptans having only a single hydrogen atom (H) bonded to the carbon atom (C) bonded to the mercapto group (—SH) (e.g., mercaptans in which the mercapto group is bonded to a secondary carbon atom; i.e., secondary mercaptans), mercaptans in which a hydrogen atom is not bonded to the above carbon atom (e.g., mercaptans in which the mercapto group is bonded to a tertiary carbon atom; i.e., tertiary mercaptans), and mercaptans in which the carbon atoms assume a resonance structure (e.g., aromatic mercaptans). It is preferable to use essentially no mercaptan having a primary mercapto group.

Examples of tertiary mercaptans include tert-butyl mercaptan, tert-octyl mercaptan, tert-nonyl mercaptan, tert-lauryl mercaptan, tert-tetradecyl mercaptan and tert-hexadecyl mercaptan. The use of a tert-alkyl mercaptan having at least four carbon atoms is preferred. From the standpoint of reducing odor from the PSA composition and the PSA sheet, it is advantageous to select a tert-alkyl mercaptan having at least 6 carbon atoms (and more preferably at least 8) carbon atoms. There is no particular upper limit in the number of carbon atoms, although the number of atoms is typically 20 or less. For example, tert-lauryl mercaptan may be preferably used.

The aromatic mercaptan may be a compound having, at least partially in the structure, a bond between an aromatic moiety (typically, an aromatic ring) and a mercapto group; or an isomer thereof; or a mercapto group-bearing derivative. Illustrative examples of aromatic mercaptans include phenyl mercaptan, 4-tolyl mercaptan, 4-methoxyphenyl mercaptan, 4-fluorobenzenethiol, 2,4-dimethylbenzenethiol, 4-aminobenzenethiol, 4-fluorobenzenethiol, 4-chlorobenzenethiol, 4-bromobenzenethiol, 4-iodobenzenethiol, 4-t-butylphenyl mercaptan, 1-naphthyl mercaptan, 1-azulenethiol, 1-anthracenethiol and 4,4′-thiobenzenethiol. An aromatic mercaptan having from about 6 to about 20 carbon atoms is preferred. For example, preferred use may be made of phenyl mercaptan.

A polymerization mixture in the form of an emulsion of acrylic polymer dispersed in water (acrylic polymer emulsion) may be prepared by means of such emulsion polymerization. The aqueous PSA composition in the art disclosed herein may be advantageously produced using this polymerization mixture or such a polymerization mixture that has been suitably worked up. Alternatively, an acrylic polymerization emulsion may be prepared by employing a polymerization method other than emulsion polymerization (e.g., solution polymerization, photopolymerization, bulk polymerization) to synthesize an acrylic polymer, then dispersing the polymer in water.

If necessary, an emulsifying agent may be used in preparing the acrylic polymer emulsion. Use may be made of an anionic, nonionic or cationic emulsifying agent for this purpose. Generally, the use of an anionic or nonionic emulsifying agent is preferred. Advantageous use may be made of such an emulsifying agent when, for example, emulsion polymerizing the monomers or when dispersing an acrylic polymer obtained by another method in water.

Examples of anionic emulsifying agents include alkyl sulfate type anionic emulsifying agents such as sodium lauryl sulfate, ammonium lauryl sulfate and potassium lauryl sulfate; polyoxyethylene alkyl ether sulfate type anionic emulsifying agents such as sodium polyoxyethylene lauryl ether sulfate; polyoxyethylene alkylphenyl ether sulfate type anionic emulsifying agents such as ammonium polyoxyethylene lauryl phenyl ether sulfate and sodium polyoxyethylene lauryl phenyl ether sulfate; sulfonate type anionic emulsifying agents such as sodium dodecylbenzene sulfonate; and sulfosuccinic acid type anionic emulsifying agents such as disodium lauryl sulfosuccinate and disodium polyoxyethylene lauryl sulfosuccinate.

Examples of nonionic emulsifying agents include polyoxyethylene alkyl ether type nonionic emulsifying agents such as polyoxyethylene lauryl ether; polyoxyethylene alkyl phenyl ether type nonionic emulsifying agents such as polyoxyethylene lauryl phenyl ether; polyoxyethylene fatty acid esters; and polyoxyethylene-polyoxypropylene block polymers. Use may also be made of radically-polymerizable emulsifying agents (reactive emulsifying agents) having a structure obtained by introducing a radically-polymerizable group (e.g., a propenyl group) into an anionic or nonionic emulsifying agent such as the above.

Such emulsifying agents may be used singly or as combinations of two or more thereof. The amount of emulsifying agent is not subject to any particular limitation, provided it is an amount capable of preparing an emulsion of the acrylic polymer. For example, the amount is suitably selected from a range of about 0.2 to about 10 parts by weight (preferably about 0.5 to about 5 parts by weight), solids basis, per 100 parts by weight of the acrylic copolymer. If the amount of emulsifying agent is too small, the desired dispersibility may be difficult to achieve. On the other hand, if the amount of emulsifying agent is too large, the adhesive performance may tend to decrease.

In addition to an acrylic polymer, the aqueous PSA composition in the art disclosed herein also comprises at least a preservative. The method of incorporating the preservative is not subject to any particular limitation. For example, advantageous use may be made of a method wherein the preservative is added to and mixed with an acrylic polymer emulsion (the preservative being either added alone or in the form of a mixture of other additives and the preservative).

The PSA composition in the art disclosed herein may also include, in addition to the acrylic polymer, a tackifying resin. Tackifying resins that may be used for this purpose include, but are not limited to, various tackifying resins such as rosins, terpenes, hydrocarbons, epoxides, polyamides, elastomers, phenols and ketones. Such tackifying resins may be used singly or as combinations of two or more thereof.

In particular, examples of rosin-type tackifying resins include unmodified rosins (raw rosins) such as rubber rosin, wood rosin and tall oil rosin; modified rosins obtained by hydrogenating, disproportionating, polymerizing or otherwise modifying these unmodified rosins (e.g., hydrogenated rosin, disproportionated rosin, polymerized rosin, and rosins that have been chemically modified in some other way); and other types of rosin derivatives. Examples of such rosin derivatives include rosin esters such as unmodified rosins that have been esterified with alcohols (i.e., esterification products of rosins), and modified rosins (e.g., hydrogenated rosins, disproportionated rosins, polymerized rosins) that have been esterified with alcohols (i.e., esterification products of modified rosins); unsaturated fatty acid-modified rosins obtained by modifying unmodified rosins or modified rosins (e.g., hydrogenated rosins, disproportionated rosins, polymerized rosins) with an unsaturated fatty acid; unsaturated fatty acid-modified rosin esters obtained by modifying rosin esters with an unsaturated fatty acid; rosin alcohols obtained by reduction of the carboxyl groups in unmodified rosins, modified rosins (e.g., hydrogenated rosins, disproportionated rosins, polymerized rosins), unsaturated fatty acid-modified rosins or unsaturated fatty acid-modified rosin esters; metal salts of rosins (especially rosin esters) such as unmodified rosins, modified rosins or various types of rosin derivatives; and rosin phenol resins obtained by thermal polymerization involving the addition of phenol to a rosin (e.g., unmodified rosin, modified rosin, various types of rosin derivatives) using an acid catalyst.

Examples of terpene-type tackifying resins include terpene resins such as α-pinene polymers, β-pinene polymers and dipentene polymers; and modified terpene resins obtained by modifying (e.g., phenolic modification, aromatic modification, hydrogenation, hydrocarbon modification) such terpene resins. Examples of such modified terpene resins include terpene-phenol resins, styrene-modified terpene resins, aromatic modified terpene resins and hydrogenated terpene resins.

Hydrocarbon-type tackifying resins include various types of hydrocarbon resins, such as aliphatic hydrocarbon resins, aromatic hydrocarbon resins, aliphatic cyclic hydrocarbon resins, aliphatic aromatic petroleum resins (e.g., styrene-olefinic copolymers), aliphatic alicyclic petroleum resins, hydrogenated hydrocarbon resins, coumarone resins and coumarone-indene resins. Examples of aliphatic hydrocarbon resins include one or more aliphatic hydrocarbon polymer selected from among olefins and dienes having about 4 or 5 carbons. Examples of olefins include 1-butene, isobutylene and 1-pentene. Examples of dienes include butadiene, 1,3-pentadiene and isoprene. Examples of aromatic hydrocarbon resins include polymers of vinyl group-bearing aromatic hydrocarbons having about 8 to 10 carbons (e.g., styrene, vinyltoluene, α-methylstyrene, indene, methylindene). Examples of aliphatic cyclic hydrocarbon resins include alicyclic hydrocarbon resins obtained by the cyclic dimerization of what is referred to as the “C4 petroleum fraction” or “C5 petroleum fraction,” followed by polymerization; polymers of cyclic diene compounds (e.g., cyclopentadiene, dicyclopentadiene, ethylidene norbornene, dipentene), or hydrogenation products thereof; and alicyclic hydrocarbon resins obtained by hydrogenating the aromatic rings of aromatic hydrocarbon resins or aliphatic-aromatic petroleum resins.

In the art disclosed herein, it is desirable to use a tackifying resin having a softening point (softening temperature) of at least about 80° C. (preferably at least about 100° C.). With such a tackifying resin, a PSA sheet having a higher performance (e.g., higher adhesiveness) can be achieved. The upper limit in the softening point of the tackifying resin is not subject to any particular limitation and may be, for example, about 170° C. or less (typically about 160° C. or less). In tackifying resins with a softening point higher than 170° C., the compatibility with the acrylic polymer may have a tendency to decrease.

The tackifying resin softening point mentioned herein is defined as the value measured based on the softening point test method (ring and ball method) described in JIS K 5902 and JIS K 2207. Specifically, a specimen is rapidly melted at as low a temperature as possible, then is filled carefully, so that no bubbles form, into a ring that has been placed on a flat metal plate. After cooling, the portion which swells out from the flat plane that includes the top edge of the ring is cut away with a small, slightly heated, knife. Next, a ring support is placed in a glass vessel (heating bath) having a diameter of at least 85 mm and a height of at least 127 mm, and glycerol is poured into the vessel to a depth of at least 90 mm. Next, a steel ball (diameter, 9.5 mm; weight, 3.5 g) and the ring filled with the specimen are immersed in the glycerol so that they do not mutually touch, and the glycerol temperature is held at 20±5° C. for 15 minutes. Next, the steel ball is placed at the center on the surface of the specimen in the ring, and this arrangement (the ball on the specimen in the ring) is then set at a fixed position on the ring support. While keeping the distance from the top edge of the ring to the glycerol surface at 50 mm, a thermometer is then set in place so that the center position of the mercury bulb in the thermometer is at the same height as the center of the ring, and the vessel is heated. The flame of the Bunsen burner used for heating is brought against the center and edge at the bottom of the container so that heating is uniform. The rate of rise in the bath temperature from the start of heating until a temperature of 40° C. has been reached must be 5.0±0.5° C. per minute. The specimen gradually softens and flows down from the ring, eventually touching the bottom plate, at which time the temperature is read off as the softening point. Measurement of the softening point is carried out simultaneously on at least two specimens, and the average of the readings is used.

This type of tackifying resin may be advantageously used in the form of an emulsion prepared by dispersing the resin in water. If necessary, the tackifying resin emulsion may be prepared using an emulsifying agent. The emulsifying agent may be of one or more types suitably selected from among emulsifying agents similar to those which can be used in preparing the acrylic polymer emulsion. The use of an anionic emulsifying agent or a nonionic emulsifying agent is generally preferred. The emulsifying agent used in preparing the tackifying resin emulsion may be the same as or different from the emulsifying agent used in preparing the acrylic polymer emulsion. Examples of suitable embodiments include embodiments in which anionic emulsifying agents are used in the preparation of both emulsions, embodiments in which cationic emulsifying agents are used in both emulsions, and embodiments in which an anionic emulsifying agent is used in one emulsion and a nonionic emulsifying agent is used in the other emulsion. The amount of emulsifying agent is not subject to any particular limitation, provided it is an amount capable of preparing an emulsion of the tackifying resin. For example, the amount of emulsifying agent may be selected from a range of about 0.2 to about 10 parts by weight (preferably from 0.5 to 5 parts by weight) per 100 parts by weight (solids basis) of the tackifying resin.

A preservative may be included in the tackifying resin emulsion. Preferred use may be made of any preservative which does not corrode the silver plate in the above-described metal corrosion test. Preservatives preferable for the PSA composition disclosed herein may also be advantageously used as preservatives in the tackifying emulsion used to prepare this composition. The aqueous PSA composition in the art disclosed herein may be prepared by mixing together an acrylic polymer emulsion and a preservative-containing tackifying resin emulsion. This aqueous PSA composition may contain, in addition to the preservative included in the tackifying resin emulsion, a preservative of the same or a different type.

The amount of preservative is not subject to any particular limitation, and may be suitably selected according to the target adhesiveness (bond strength, etc.). For example, it is preferable to use the tackifying resin in an amount (solids basis) of from about 10 to about 100 parts by weight (more preferably 15 to 80 parts by weight, and even more preferably 20 to 60 parts by weight) per 100 parts by weight of the acrylic polymer.

If necessary, a crosslinking agent may be used in the PSA composition. The type of crosslinking agent used is not subject to any particular limitation, and may be suitably selected from among known or conventional crosslinking agents (e.g., isocyanate-type crosslinking agents, epoxy-type crosslinking agents, oxazoline-type crosslinking agents, aziridine-type crosslinking agents, melamine-type crosslinking agents, peroxide-type crosslinking agents, urea-type crosslinking agents, metal alkoxide-type crosslinking agents, metal chelate-type crosslinking agents, metal salt-type crosslinking agents, carbodiimide-type crosslinking agents, and amine-type crosslinking agents). Either an oil-soluble crosslinking agent or a water-soluble crosslinking agent may be used here as the crosslinking agent. The crosslinking agent may be used singly or as a combination of two or more thereof. The amount of crosslinking agent is not subject to any particular limitation, and may be selected from a range of up to about 10 parts by weight (e.g., from about 0.005 to about 10 parts by weight, and preferably from about 0.01 to about 5 parts by weight) per 100 parts by weight of the acrylic polymer.

If necessary, the PSA composition may include an acid or base (e.g., ammonia water) used for such purposes as pH adjustment. Examples of other optional ingredients that may be incorporated in the composition include various common additives in the field of aqueous PSA compositions, such as viscosity modifiers (thickeners, etc.), leveling agents, release modifiers, plasticizers, softeners, fillers, colorants (pigments, dyes, etc.), surfactants, antistatic agents, antidegradants, ultraviolet absorbers, antioxidants, light stabilizers and the like.

The PSA layer in the art disclosed herein may be advantageously formed by applying an aqueous PSA composition like that described above to a given surface, then drying or curing. When applying the PSA composition (typically, by coating), use may be made of a conventional coater (e.g., gravure roll coater, reverse roll coater, kiss roll coater, dip roll coater, bar coater, knife coater, spray coater). The thickness of the PSA layer is not subject to any particular limitation, and may be, for example, from about 2 μm to about 200 μm (preferably from about 5 μm to about 100 μM).

The PSA sheet having such a PSA layer may be manufactured by any of various methods. For example, in the case of a PSA sheet with substrate, use may be made of a method wherein the PSA composition is applied directly to a substrate, then dried or cured so as to form a PSA layer on the substrate, following which a release liner is laminated onto the PSA layer; or a method wherein a PSA layer formed on a release liner is attached to a substrate, thereby transferring the PSA layer to the substrate, and the release liner is used in situ to protect the PSA layer.

In the PSA sheet disclosed herein, the substrate which supports (backs) the PSA layer may be, for example, a plastic film such as a polyolefin (e.g., polyethylene, polypropylene, ethylene-propylene copolymer) film, a polyester (e.g., polyethylene terephthalate) film, a vinyl chloride resin film, a vinyl acetate resin film, a polyimide resin film, a polyamide resin film, a fluororesin film, or cellophane; a type of paper, such as Japanese paper, kraft paper, glassine, wood-free paper, synthetic paper or topcoated paper; a woven or nonwoven fabric composed of any of various types of fibrous substances (whether natural fibers, semi-synthetic fibers, or synthetic fibers, examples of which include cotton fibers, staple fibers, Manila hemp, pulp, rayon, acetate fibers, polyester fibers, polyvinyl alcohol fibers, polyamide fibers and polyolefin fibers), either singly or as a blend; a rubber sheet made of, e.g., natural rubber or butyl rubber; foam sheets made of foam such as expanded polyurethane or expanded polychloroprene rubber; a metal foil such as aluminum foil and copper foil; or a composite thereof. The plastic film may be of an unoriented type or an oriented (monoaxially oriented or biaxially oriented) type. The substrate may be in the form of a single layer, or may be in the form of a laminate.

The substrate may optionally contain various additives, such as fillers (e.g., inorganic fillers, organic fillers), antidegradants, antioxidants, ultraviolet absorbers, antistatic agents, lubricants, plasticizers, colorants (e.g., pigments, dyes), and the like. A known or conventional surface treatment, such as corona discharge treatment, plasma treatment or primer coating, may be applied to the substrate surface (in particular, the surface on the side where the PSA layer is provided). Such surface treatment may be, for example, treatment for increasing the anchorability of the PSA layer to the substrate. The thickness of the substrate may be suitably selected according to the intended application, and is generally in a range of from about 10 μm to about 500 μm (preferably from about 10 μm to about 200 μm). If the substrate thickness is too small, the strength of the substrate or the PSA sheet diminishes, which may tend to lower the handleability (workability) during manufacture or use. On the other hand, if the substrate thickness is too large, the PSA sheet will become too strong, which may lower its ability to conform to the surface shape (steps, etc.) of the adherend.

The release liner which protects or supports the PSA layer (or may have both protective and supporting functions) is not subject to any particular limitation in the material or construction thereof; that is, any suitable release liner may be selected for use from among known release liners. For example, advantageous use may be made of a release liner with a construction wherein release treatment has been applied to at least one surface of a substrate (typically, a release treatment layer made of a release treatment agent has been provided). The substrate in such a release liner (i.e., the substrate which is subjected to release treatment) may be suitably selected for use from among substrates similar to those described above as substrates making up the PSA sheet (e.g., various types of plastic films, papers, fabrics, rubber sheets, foam sheets, metal foils, and composites thereof). A known or conventional release treatment agent (examples of which include silicone, fluorochemical, and long-chain alkyl-type release treatment agents) may be used to form the release treatment layer. Alternatively, a low-adhesion substrate composed of a fluoropolymer (e.g., polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer) or a low-polarity polymer (e.g., olefin resins such as polyethylene and polypropylene) may be used as the release liner without applying any particular release treatment. It is also possible to use as the release liner a low-adhesion substrate to the surface of which a release treatment has been applied.

The thicknesses of the substrate and the release treatment layer making up the release liner are not subject to any particular limitations and may be suitably selected according to the intended purpose and other considerations. For example, the overall thickness of the release liner (in a release liner having a release treatment layer on the substrate surface, the overall thickness which includes the substrate and the release treatment layer) is preferably at least about 15 μm (typically from about 15 μm to about 500 μm), and more preferably from about 25 μm to about 500 μm.

In cases where crosslinking is carried out when the PSA layer is formed, depending on the type of crosslinking agent used (e.g., thermal crosslinking-type agents which crosslink under heating, photocrosslinking-type agents which crosslink on exposure to ultraviolet light), crosslinking may be carried out by a known or conventional crosslinking method in a specific production step. For example, in cases where the crosslinking agent used is a thermal crosslinking-type agent, the thermal crosslinking reaction may be made to proceed in parallel with or simultaneous with drying of the PSA composition after it has been applied by coating. Specifically, depending on the type of thermal crosslinking agent, crosslinking may be carried out together with drying by heating to a temperature at or above the temperature at which the crosslinking reaction proceeds.

In the art disclosed herein, although no particular limitation is imposed on the solvent insolubles (crosslinked acrylic polymer) in the PSA making up the PSA layer, it is generally desirable for such insolubles to account for about 15 to about 70 wt % of the overall PSA layer. As used herein, “solvent insolubles” refers to the weight ratio of insolubles that remains following extraction of the crosslinked PSA with ethyl acetate. Here, it is desirable for the weight-average molecular weight of the solvent solubles (the acrylic polymer obtained by extracting the PSA with tetrahydrofuran) in the PSA, expressed as the polystyrene equivalent molecular weight obtained by gel permeation chromatography (GPC), to be in a range of from about 10×10⁴ to about 200×10⁴ (preferably from about 20×10⁴ to about 160×10⁴). This weight-average molecular weight can be measured with an ordinary GPC system (e.g., a model HLC-8120 GPC system manufactured by Tosoh Corporation; using a TSKgel GMH-H(S) column). The weight ratio of solvent insolubles and the weight-average molecular weight of the solvent solubles may be set as desired by suitably adjusting, for example, the proportion of functional group-bearing monomers relative to the overall monomer components, the type and amount of chain transfer agent, and the type and amount of crosslinking agent.

Regarding the materials making up the PSA sheet disclosed herein and the materials used in the PSA sheet manufacturing process, including both preservatives as well as other materials, it is preferable to avoid or minimize the use of materials capable of becoming a source of volatile compounds (e.g., sulfur-bearing gases such as H₂S and SO₂) such as may corrode metals. For example, it is preferable to select materials which do not readily generate metal-corroding gases as the above chain transfer agents; materials other than chain transfer agents used to synthesize the acrylic polymer (e.g., emulsifying agents, polymerization initiators); tackifying agents, emulsifying agents and various other additives that may be included in the tackifying resin emulsion; crosslinking agents and various other additives that may be included in the PSA composition; and the PSA sheet base and additives therein.

The PSA sheets disclosed herein enables metal corrosion and undesirable effects associated therewith (poor electrical contact, diminished quality of appearance, etc.) to be reliably prevented or minimized. These PSA sheets can thus be advantageously used for such purposes as bonding components, surface protection, displaying information, sealing or filling holes and gaps, and damping vibrations and impact at the interior of housings for television sets (e.g., liquid-crystal, plasma and cathode ray TVs), computers (e.g., displays and main units), acoustic equipment and various other types of electrical appliances, office automation equipment and the like. These PSA sheets are especially preferred for use in environments (e.g., the housing of a liquid-crystal TV) where the temperature within the housing tends to rise with use of the electronic device, facilitating the generation of metal-corroding gases from the preservative and in turn promoting metal corrosion. With the PSA sheet disclosed herein, high metal anti-corrosion effects can be exhibited even in such a manner of use.

The art disclosed herein can be preferably applied to, for example, double-sided PSA sheets having a sheet-like substrate (typically a nonwoven or some other porous substrate) provided on each side thereof with a PSA layer. In PSA sheets having such a construction, the amount of PSA contained per unit weight of the PSA sheet is generally large, as a result of which the amount of preservative also tends to be large. In the art disclosed herein, even a PSA sheet containing a large amount of preservative per unit weight thereof, owing to the use of a preservative having little tendency to corrode metal as described above, may function as a PSA sheet capable of minimizing metal corrosion. Although not subject to any particular limitation, the thickness of the PSA layers in the double-sided PSA sheet may be set in a range of from about 20 μm to about 150 μm per side.

The present specification also provides any of the aqueous PSA compositions disclosed herein, which gives (typically by drying or curing) a PSA that, in a metal corrosion test carried out by placing 1 g of PSA and a silver plate so as not to be in mutual contact within a 50 mL vessel and then closing and holding the vessel at 85° C. for one week, does not corrode the silver plate. These PSA compositions may be advantageously used in the production of, for example, any of the PSA sheets disclosed herein. Moreover, because these PSA compositions are able to form a PSA having little tendency to corrode metal as indicated above, they are highly suitable for use in the formation of PSA (not only in sheet form, but also in bulk or in various other shapes) for such purposes as sealing, filling and cushioning at the interior of electronic device housings and in other places.

There may be cases in which it is desirable to change the type of preservative used in the aqueous PSA composition so as to counteract or prevent the generation of resistant microorganisms. When investigating such changes in the type of preservative, the art disclosed herein may be helpful for selecting a preservative that does not corrode metal or for designing a PSA sheet that does not corrode metal and a PSA composition suitable for manufacturing such a PSA sheet.

### EXAMPLES

Several examples of the invention are described below, although these examples are not intended to limit the scope of the invention. In the description that follows, unless noted otherwise, all references to “parts,” “%” and “ppm” are based on the weight of non-volatiles.

### Example 1

A reaction vessel equipped with a condenser, a nitrogen inlet, a thermometer and a stirrer was charged with 40 parts of ion-exchanged water, and flushed with nitrogen by stirring at 60° C. for more than one hour while introducing nitrogen gas. 0.2 part of 2,2′-azobis[2-(5-methyl-2-imidazolin-2-yl)propane]dihydrochloride (a polymerization initiator) was added to the reaction vessel. While maintaining the system at 60° C., a monomer emulsion was gradually added thereto in a dropwise manner over 3 hours, thereby causing the emulsion polymerization reaction to proceed. The monomer emulsion used was one that had been obtained by adding 60 parts of butyl acrylate, 40 parts of 2-ethylhexyl acrylate, 2 parts of methyl acrylate, 3 parts of acrylic acid and 1.5 parts of sodium polyoxyethylene lauryl sulfate (emulsifying agent) to 30 parts of ion-exchanged water and emulsifying. After dropwise addition of the monomer emulsion was completed, the system was held at 60° C. for another 3 hours, then 0.15 part of hydrogen peroxide solution and 0.2 part of ascorbic acid were added. The system was cooled to room temperature, following which the pH was adjusted to 7 by the addition of 10% ammonia water, thereby giving an aqueous dispersion of an acrylic polymer (aqueous dispersion-type acrylic polymer).

A preservative was added to this aqueous dispersion, thereby preparing an aqueous dispersion-type PSA composition according to the present example. As the preservative, 2,2-dibromo-2-cyanoacetamide (available from Tokyo Chemical Industry Co., Ltd.) was used. The preservative was added in an amount of 2.0×10⁻⁵ part per part of the acrylic polymer dispersion (i.e., 20 ppm).

The PSA composition was coated onto a release liner having a release treatment layer obtained with a silicone release agent (trade name of the release liner: “75EPS (M) Cream (Modified)”; available from Oji Paper Co., Ltd.) and dried at 100° C. for 2 minutes, thereby forming a PSA layer having a thickness of about 60 μm. Two sheets of this release liner with PSA layer were prepared and their PSA layers were respectively attached to each side of a nonwoven substrate (having a basis weight of 14 g/m², available from Daifuku Paper Manufacturing Co., Ltd. under the trade name SP Genshi-14), thereby producing a double-sided PSA sheet. Each adhesive face of this double-sided PSA sheet continued to be protected by the release liners used in producing the PSA sheet.

### Example 2

In this example, 2-methyl-4-isothiazolin-3-one (available as a 9.5% aqueous solution from Sigma Aldrich Co. under the trade name ProClin 950) was used instead of the 2,2-dibromo-2-cyanoacetamide used in Example 1. The amount per part of the acrylic polymer dispersion was set to 2.1×10⁻⁴ part (i.e., 20 ppm). Aside from this, an aqueous dispersion-type PSA composition was obtained in the same way as in Example 1, and this composition was used to produce a double-sided PSA sheet in the same way as in Example 1.

### Example 3

In this example, a mixture of 5-chloro-2-methyl-4-isothiazolin-3-one and 2-methyl-4-isothiazolin-3-one in a weight ratio of 3:1 (available as a 1.5% aqueous solution from Sigma Aldrich Co. under the trade name ProClin 200) was used instead of the 2,2-dibromo-2-cyanoacetamide used in Example 1. The amount per part of the acrylic polymer dispersion was set to 1.3×10⁻³ part (i.e., 20 ppm). Aside from this, an aqueous dispersion-type PSA composition was obtained in the same way as in Example 1, and this composition was used to produce a double-sided PSA sheet in the same way as in Example 1.

### Example 4

In this example, methylene dithioisocyanate (available from Tokyo Chemical Industry Co., Ltd.) was used instead of the 2,2-dibromo-2-cyanoacetamide used in Example 1. The amount per part of the acrylic polymer dispersion was set to 2.0×10⁻⁵ part (i.e., 20 ppm). Aside from this, an aqueous dispersion-type PSA composition was obtained in the same way as in Example 1, and this composition was used to produce a double-sided PSA sheet in the same way as in Example 1.

### Example 5

Aside from not using methylene dithioisocyanate, an aqueous dispersion-type PSA composition was obtained in the same way as in Example 4, and this composition was used to produce a double-sided PSA sheet in the same way as in Example 1.

The following measurements and evaluations were carried out on the PSA compositions or PSA sheets obtained in the above examples. The results are shown in Table 1. This table also shows the types and contents (concentrations) of preservatives used in the respective examples.

### Anti-Spoilage Test

Twenty grams of an aqueous PSA composition was added to a 50 mL screw cap bottle, following which the bottle was capped and closed. The bottle was warmed at 30° C. for one week in a closed state, following which the cap on the bottle was opened and the anti-spoilage properties were evaluated by sensory testing the bottle contents for the presence of a putrid smell. The results are indicated in Table 1. The anti-spoilage properties were rated as “Good” when a putrid smell was not detected, and were rated as “NG” when a putrid smell was detected.

### Adhesive Strength Measurement

The release liner covering one adhesive face of the double-sided PSA sheet was peeled off, and a 25 μm thick polyethylene terephthalate (PET) film was attached as a backing. The resulting backed PSA sheet was cut to a width of 20 mm and a length of 100 mm as a measurement sample. The release liner was peeled from the other adhesive face of the sample, following which the sample was press-bonded to a stainless steel (SUS: BA304) plate by a single back-and-forth pass with a 2 kg roller. The applied sample was held at 23° C. for 30 minutes, following which the 180° peel bond strength was measured in general accordance with JIS Z 0237 using a tensile testing machine at a test rate of 300 mm/min and within a measurement environment of 23° C. and 50% RH.

### Metal Corrosion Test

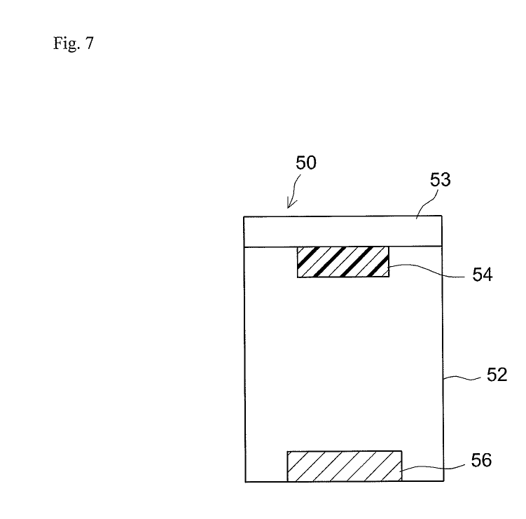

Each of the PSA sheets from which the release liners had been peeled from both adhesive faces (and which thus consisted of the non-releasable substrate and the PSA layers provided on each side thereof) in an amount of 1.0 g and a polished silver plate (silver purity>99.95%; size, 1 mm×10 mm×10 mm) were furnished, and metal corrosion by the PSA sheet was evaluated using the metal corrosion tester 50 shown in FIG. 7. That is, the PSA sheet 54 and the silver plate 56 were placed within a 50 mL clear glass screw cap bottle 52 in such a way as to not be in direct mutual contact, and the bottle 52 was closed. Specifically, the silver plate 56 was placed on the bottom surface of the screw cap bottle 52, and the PSA sheet 54 was attached to the back of the bottle cap 53, the cap 53 was closed and the bottle 52 was thereby sealed. The bottle 52 was then held at 85° C. for one week. Metal corrosion was evaluated by comparing the silver plate following the test (after one week had elapsed) with an unused silver plate (before the test), and visually checking for the presence or absence of corrosion (which was judged based on changes in appearance, such as a loss of metal luster and discoloration). The metal corrosion results are indicated in Table 1 as “Yes” when corrosion was observed, and as “No” when corrosion was not observed.

TABLE 1

| | Example | Example | Example | Example | Example |
|---|---|---|---|---|---|
| | 1 | 2 | 3 | 4 | 5 |
| Preservative | | | | | |
| Type | A | B | B + C | D | none |
| Amount (ppm) | 20 | 20 | 20 | 20 | — |
| Bond strength (N/20 mm) | 7.5 | 7.0 | 7.8 | 7.6 | 7.1 |
| Anti-spoiling properties | good | good | good | good | NG |
| Metal corrosion | no | no | no | yes | no |

Preservative A: 2,2-Dibromo-2-cyanoacetamide; B: 2-Metnyl-4-isotmazolin-3-one; C: 5-Chloro-2-methyl-4-isothiazolin-3-one; D: Methylene dithioisocyanate.

As shown in Table 1, the PSA sheets in Examples 1 to 3 which were obtained using PSA compositions that contained one or a combination of Preservatives A, B, and C, none of which having a thiocyanate group or a thioacetal group, were all confirmed to not corrode metals in the metal corrosion test. These PSA compositions according to Examples 1 to 3 all exhibited a degree of anti-spoilage properties that was sufficient for practical purposes.

By contrast, the PSA sheet in Example 4 which was obtained using a PSA composition that contained Preservative D having a thiocyanate group caused metal corrosion. In Example 5 wherein a preservative was excluded from the formulation in Example 4, metal corrosion was avoided, but spoilage of the PSA composition occurred. The PSA sheets obtained in Examples 1 to 5 all exhibited a good adhesive strength, regardless of the type of preservative or whether or not they contained a preservative.

The PSA sheets obtained in Examples 1 to 4 each contained about 3.3×10⁻⁵ g of preservative per gram of the sheet. Therefore, the results of the above metal corrosion test may be treated in the same way as the results obtained by placing 3.3×10⁻⁵ g of preservative and a silver plate so as not to be in mutual contact within a 50 mL vessel and then closing and holding the vessel at 85° C. for one week. From these results, Preservatives A, B, and C were found to be preservatives which do not corrode the silver plate in a metal corrosion test carried out by placing 1.7×10⁻⁵ g of preservative and a silver plate so as not to be in mutual contact within a 50 mL vessel and then closing and holding the vessel at 85° C. for one week.

The embodiments disclosed in this application are to be considered in all respects as illustrative and not limiting. The scope of the invention is indicated by the appended claims rather than by the foregoing description, and all changes and modifications which come within the meaning and range of equivalency of the claims are intended to be embraced therein.

What is claimed is:

1. A method of manufacturing a pressure-sensitive adhesive sheet which is adapted for use inside an electronic device and comprises a pressure-sensitive adhesive layer formed from an aqueous pressure-sensitive adhesive composition, the method comprising the steps of:
preparing an aqueous pressure-sensitive adhesive composition containing an adhesive ingredient and a preservative in an aqueous medium, which preservative, in a metal corrosion test carried out by placing 1.7×10⁻⁵ g of the preservative and a silver plate so as not to be in mutual contact within a 50 mL vessel and then closing and holding the vessel at 85° C. for one week, does not corrode the silver plate; and
forming the pressure-sensitive adhesive layer by drying the pressure-sensitive adhesive composition.

2. The method according to claim 1, wherein the pressure-sensitive adhesive composition contains the preservative in a concentration of at least 1 ppm.

3. The method according to claim 1, wherein the pressure-sensitive adhesive composition does not exhibit spoilage in an anti-spoilage test carried out by placing 20 g of the composition in a 50 mL vessel in open air and then closing and holding the vessel at 30° C. for one week.

4. The method according to claim 1, wherein the pressure-sensitive adhesive composition comprises an acrylic polymer as a base polymer of the adhesive ingredient and is an emulsion of the acrylic polymer dispersed in water.

5. The method according to claim 1, wherein the preservative is a compound without either a thiocyanate group or a thioacetal group.

6. A pressure-sensitive adhesive sheet adapted for use inside an electronic device, comprising a pressure-sensitive adhesive layer formed from an aqueous pressure-sensitive adhesive composition comprising an adhesive ingredient and a preservative in an aqueous medium,
wherein, in a metal corrosion test carried out by placing 1 g of the pressure-sensitive adhesive sheet and a silver plate so as not to be in mutual contact within a 50 mL vessel and then closing and holding the vessel at 85° C. for one week, the pressure-sensitive adhesive sheet does not corrode the silver plate.

7. The sheet according to claim 6, which is a double-sided pressure-sensitive adhesive sheet comprising a substrate having on each side thereof the pressure-sensitive adhesive layer.

8. The sheet according to claim 6, which is adapted for use in bonding inside an electronic device.

9. The sheet according to claim 6, wherein the preservative is a compound without either a thiocyanate group or a thioacetal group.

10. A pressure-sensitive adhesive sheet, which is manufactured by the method according to claim 1 and is adapted for use in bonding within an electronic device.
